(19) United States
(12) Patent Application Publication
(10) Pub. No.: US 2006/0289285 A1
(43) Pub. Date: Dec. 28, 2006

(54) Movable contact and manufacturing method thereof

(75) Inventors: Yousuke Chikahisa, Hyogo (JP); Koji Tanabe, Osaka (JP); Yoshiharu Abe, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/475,188

(22) Filed: Jun. 27, 2006

(30) Foreign Application Priority Data
Jun. 28, 2005 (JP) 2005-187668

(51) Int. Cl. H01H 9/00

(52) U.S. Cl. 200/310; 313/511; 313/512; 345/156; 345/173

(57) ABSTRACT

A movable contact to be used for various electronic equipment is provided. An electroluminance layer (12) is formed on a main surface (11a) of a substrate (11), and the substrate (11) and the electroluminance layer (12) constitute an electro-luminance element (13). A diaphragm (15) in essentially a dome-like shape is adhered to a specified spot of main surface (12a) of the electroluminance layer (12), constituting the movable contact (16) which includes the electroluminance element (13) and the diaphragm (15). The electroluminance element (13) is molded into essentially a dome-like shape along the shape of the diaphragm (15). A spacer for placing the diaphragm (15) is eliminated, so an inexpensive movable contact in a simple structure and a production method thereof is provided.

### TECHNICAL FIELD

This invention relates to a moving contact to be used for a variety of electronic equipment, more particularly to a moving contact illuminating its operating part thereof and a manufacturing method thereof.

### BACKGROUND ART

In recent years, electronic equipment especially a potable terminal such as a portable phone illuminating its operational part with light emitted by an electroluminescence (EL) element is increasing in number, for alleviating an inconvenience in recognizing and operating a switch or a push button in an operating part even when it is used in a dark environment. More easy operation and low cost type is further demanded.

FIG. 4 is an exploded cross-sectional view of a conventional switch. FIG. 4 shows that EL layer 2 is composed of a light permeable electrode layer, a luminous body layer, a dielectric layer, a rear electrode layer, and an insulating layer covering the other layers. They are stacked on a main surface 1a of substrate 1 which is a bendable and light permeable film, forming EL layer 2. Substrate 1 and EL layer 2 constitute EL element 3.

A plurality of through-holes 4S is formed at a specified place of spacer 4 made of insulating resin. Spacer 4 is adhered to main surface 2a which is a main surface side of EL element 3 with an adhesive (not illustrated) applied to both upper and lower sides of the spacer.

Diaphragm 5 of thin conductive metal plate is formed essentially in a dome-like shape and is placed in through-hole 4S formed in spacer 4 with a predetermined spacing with other diaphragms. Diaphragm 5 is formed in a convex shape and its central top portion 5T is curved round, which is adhered to a main surface side of EL element 3 namely main surface 2a of EL layer 2 with an adhesive (not illustrated). EL element 3 and diaphragm 5 constitute movable contact 6.

Main surface 4a of spacer 4 of the movable contact 6 is adhered to main surface side 7a of wiring substrate 7 with an adhesive (not illustrated), both sides of the substrate are formed with wiring patterns. Outer periphery 5E of diaphragm 5 is placed on certain fixed contacts 8 disposed on main surface 7a of wiring substrate 7, and center portion 5F of diaphragm 5 is opposed to fixed contact 8 with a certain distance. Movable contact 6 and wiring substrate 7 constitute the switch.

Thus constituted switch is placed at a rear side such as of a push button or a display sheet, which is installed in an operating part of electronic equipment. The light permeable electrode layer and the rear electrode layer of EL element 3 and fixed contact 8 of wiring substrate 7 are connected to an electronic circuit (not illustrated) of electronic equipment though a wiring pattern and a connector.

In this constitution, when a voltage is applied by the electronic circuit of electronic equipment to the light permeable electrode layer and the rear electrode layer of EL element 3, EL element emits light illuminating the push button and the display sheet in electronic equipment from backward. Thus, the operating part can be recognized and can be operated easily even when the movable contact is used in a dark environment.

When EL element 3 disposed on diaphragm 5 is pressed toward P4 from above by the push button or the like, EL element 3 warps downward depressing center top portion 5T of diaphragm 5. Diaphragm 5 then is reversely moved and central portion 5F touches fixed contact 8, making electrical connections and disconnections between fixed contacts 8 and switching various functions of electronic equipment.

Prior art of this invention is disclosed by Unexamined Japanese Patent Application No. H11-250758, for instance.

However, with above conventional movable contact, spacer 4 is adhered to the main surface side of EL element 3 (main surface 2a of EL layer 2) placing diaphragms 5 in through-holes 4S, increasing number of constituent component so that requiring many manufacturing process and a long manufacturing period of time.

### SUMMARY OF THE INVENTION

The invention solves such ordinary problems, and provides a relatively simple structured and less expensive movable contact, and a production method of the movable contact.

The movable contact of the invention is composed by adhering a diaphragm formed in a convex shape with a center part curved like a dome shape to a main surface side of an EL element. With this structure, a spacer to place the diaphragm becomes unnecessary, so that a simple construction and less expensive movable contact can be provided.

In the movable contact of this invention, the diaphragm is adhered to a main surface side of the EL element and is covered by a separator. With this constitution, an inconvenience such as dust is attached to the diaphragm while the mobile contact is transported or the diaphragm is adhered to a wiring substrate can be avoided, so the diaphragm is allowed to contact the fixed contacts in electrically and mechanically a stable state.

With the movable contact of the invention, at least one of a light permeable electrode layer, a luminous body layer and a rear electrode layer of the EL element is formed in a vicinity of the diaphragm. Accordingly, it is unnecessary to form any of these layers faraway the vicinity of the diaphragm, so that an inexpensive EL element and an inexpensive movable contact can be provided.

According to the manufacturing method of the invention, the diaphragm is adhered to a main side of the EL element, and the EL element is molded along the diaphragm, forming the movable contact in essentially a dome-like shape which center part is curved round in a convex shape. The diaphragm is intimately adhered to the main surface side of the EL element, so when the EL element is press-operated, the diaphragm securely moves reversely

The manufacturing method of a movable contact of the invention includes a step of preparing the light permeable and bendable substrate, a step of forming the electroluminescence layer on a main surface of the substrate by printing, a step of adhering the diaphragm to the main surface of an EL layer at a predetermined spacing with other diaphragms, a step of adhering the separator to the diaphragm for covering the diaphragm, and a step of molding the substrate and the EL layer along a shape of the diagram by applying a heating and pressuring process from an other main surface of the substrate with the diaphragm covered.

### BRIEF DESCRIPTION OF THE DRAWINGS

FIG. 1 is a cross-sectional view of a movable contact in accordance with an exemplary embodiment of this invention.

FIG. 2 is an exploded cross-sectional view of the movable contact in accordance with the exemplary embodiment of the invention illustrated in FIG. 1

FIG. 3 is an exploded cross-sectional view of a switch in accordance with the exemplary embodiment of the invention illustrated in FIG. 1.

FIG. 4 is an exploded cross-sectional view of a conventional switch.

### REFERENCE MARKS IN THE DRAWINGS

7 wiring substrate

8 fixed contact

11 substrate

12 electroluminescence (EL) layer

13 electroluminescence (EL) element

15 diaphragm

16 movable contact

17 separator

18 forming jig

### DETAILED DESCRIPTION OF THE PREFERRED EMBODIMENT

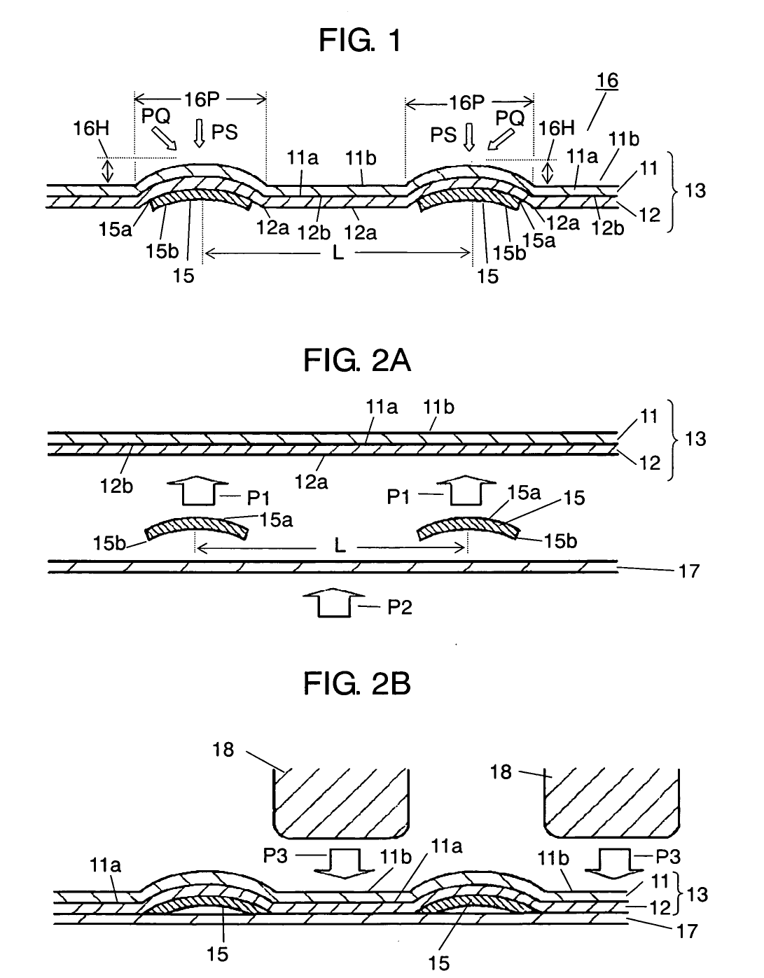

Following, an exemplary embodiment of this invention is explained using FIGS. 1 to 3. FIG. 1 is a cross-sectional view of a movable contact in accordance with an exemplary embodiment of the invention. A light permeable and bendable substrate 11 is formed of a film such as polyethylene terephthalate or polyamide in a thickness of about 5 to 50μm. On main surface lla of substrate 11, a light permeable electrode layer is formed by printing light permeable synthetic resin dispersed with indium oxide tin or the like and conductive resin such as polyethylene dioxi-thyophene or the like though they are not illustrated.

On a main surface of the light permeable electrode layer not illustrated, a luminous body layer made of synthetic resin such as fluorocarbon rubber dispersed with phosphor a luminescent basic material such as zinc sulfide, a dielectric layer made of a synthetic resin dispersed with such as barium itanate, a rear electrode layer made of a resin dispersed with silver, carbon or the like, an epoxy resin covering those layers, and an insulating layer such as polyester resin are successively stacked by printing, forming EL layer 12. Substrate 11 and EL layer 12 are jointed, constituting EL element 13.

Diaphragm 15 is made of a thin conductive metal plate such as copper alloy or steel, and its outer appearance is in a convex or a dome-like shape curved particularly in a center part. Diaphragm 15 is attached to main surface 12a of EL layer 12 with an adhesive such as acryl or butyl rubber (not illustrated) with a predetermined spacing L.

A portion of EL element 13 where diaphragm 15 is attached is formed in a convex shape fitting the shape of diaphragm 15. Almost an entire part of main surface 15a of diaphragm 15 is intimately connected to main surface 12a of EL layer 12, constituting movable contact 16 of the invention.

In other word, movable contact 16 of this invention includes a plurality of diaphragms 15 made of a thin conductive metal plate, formed in a dome-like shape and is attached to main surface 12a of EL layer 12 with a certain spacing between each other, and a plurality of protrusion 16P composed of at least three layers, which are substrate 11, EL layer 12 and diaphragm 15 which is protruded toward other main surface 11b of substrate 11 along the shape of. diaphragm 15.

Protrusion 16P is made up by main surface 12a of EL layer intimately connected to main surface 15a of diaphragm 15, and other main surface 12b of EL layer 12 intimately connected to main surface 11a of substrate 11. Protrusion 16P is composed of at least three layers, namely substrate 11, EL layer 12 and diaphragm 15 intimately stacked. A shape of protrusion 16P is essentially identical to that of diaphragm 15.

Height of protrusion 16P or length 16H above other main surface 11b of substrate 11 is determined by a shape, material and a thickness of diaphragm 15 and of EL element 13. The height can be controlled and changed with heating and pressurizing conditions of forming jig 18 that is explained later.

As shown in FIG. 1, diaphragm 15 is pressed from right above toward a PS direction in usual operation. However, occasionally it can be pressed obliquely toward a PQ direction. Even under this usage condition, since diaphragm 15 of this invention is formed intimately attached to EL element 13, its normal position can be maintained without deviation.

FIG. 2A is an exploded cross-sectional view of movable contact 16 illustrated in FIG. 1. Movable contact 16 includes EL element 13 composed of substrate 11 and EL layer 12, as is shown in FIG. 2A. Main surface 11a of substrate 11 and other main surface 12b of EL layer 12 are connected. EL layer 12 is composed of a light permeable electrode layer, a luminous body layer, a dielectric layer, a rear electrode layer and an insulating layer stacked in this order.

A plurality of diaphragms 15 is moved along a moving direction P1 and is attached to main surface 12a of EL layer 12 with adhesive (not illustrated) keeping a predetermined spacing L. Then, separator 17 a film in a thickness of 50 to 100μm such as of polyethylene terephthalate(PET) is moved along a moving direction P2 and is attached to main surface 12a of EL layer 12, covering diaphragm 15 on other main surface 15b.

Then, as shown in FIG. 2B, forming-jig 18 is moved along a moving direction P3 applying a heat and pressure to an other surface side of EL element 13 between diaphragm 15 and other diaphragm 15, a predetermined spot on other main surface 11b of substrate 11. With this heating and pressurizing process, EL element 13 is molded into essentially a dome-like shape along the shape of diaphragm 15. In this process, diaphragm 15 is preferably molded into a dome-like shape having a curved round portion. If diaphragm 15 is in a dome-like shape, EL layer 12 and substrate 11 attached to the diaphragm can be formed without receiving an excessive stress and molded fitting the shape of the diaphragm. However, as long as diaphragm 15 is in a convex shape, little flattened shape is allowed. The predetermined spot on other main surface 11b of substrate 11 is a spot where substrate 11, EL layer 12 and separator 17 are stacked but diaphragm 15 is not formed.

By forming-jig 18 applying the heating and pressurizing process to EL element 13, movable contact 16 can be provided, in which a main surface side of EL element 13 (main surface 12a of EL layer 12) and diaphragm 15 are intimately connected. Diaphragm 15 put between separator 17 and EL element 13 or covered with them is stored, or transferred to a next step of processing.

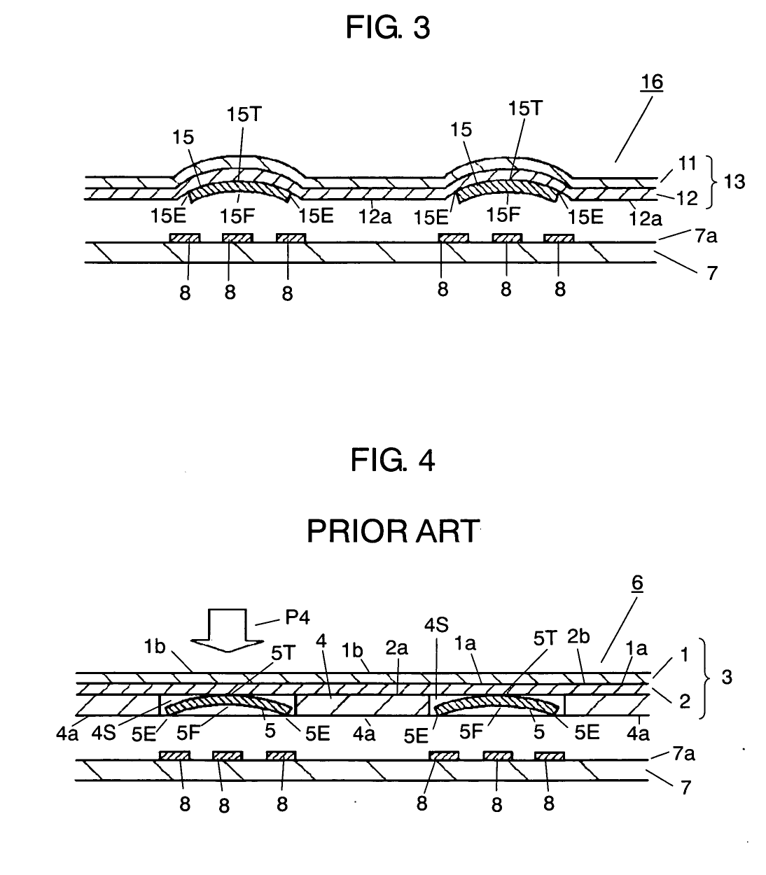

FIG. 3 shows an exploded cross-sectional view of the switch taken out of storage and transferred to a next stage of processing. FIG. 3 shows a state where separator 17 is peeled off and wiring substrate 7 having a plurality of wiring patterns (not illustrated) on upper and lower sides of the substrate is placed on the main surface side of EL element 13, namely main surface 12a of EL layer 12 to which diaphragm 15 is attached. A plurality of fixed contacts 8 is disposed on main surface 7a of substrate 7, and an outer periphery 15E of diaphragm 15 is placed on some of fixed contacts 8. Center part 15T of diaphragm 15 is opposed to fixed contact 8 with a certain distance. EL element 13 and wiring substrate 7 constitute the switch.

Separator 17 is attached to EL element 13 and covering diaphragm 15 while it is stored before transferred to the next stage of processing step or when transferred to the next step. If separator 17 is peeled off just before the element is attached to main surface 7a of wiring substrate 7, diaphragm 15 is prevented fiom being attached by dusts and other adhesives, so that the switch is assembled in a clean condition.

EL element 13 a constituent of movable contact 16 is molded into essentially the dome-like shape along diaphragm 15, and almost an entire part of diaphragm 15 is intimately adhered to the main surface side of EL element 13, so that malfunction such as a fall off or a positional deviation of diaphragm 15 which might occur when separator 17 is peeled off or when the element is attached to wiring substrate 7 is prevented, allowing an easy assemble of the switch.

Thus constituted switch is placed at a rear side of a push button, a display or the like, and is installed in an operating part of electronic equipment. The light permeable electrode layer and the rear electrode layer of EL element 13 and fixed contact 8 of wiring substrate 7 are connected to an electronic circuit (not illustrated) of electronic equipment through the wiring pattern and a connector.

In above constitution, when a voltage is applied by the electronic circuit of electronic equipment to the light permeable electrode layer and the rear electrode layer of EL element 13, EL element 13 emits light illuminating the push button and the display sheet from a back side of electronic equipment. Therewith, even when the movable contact is used in a dark place, an operating part is easily recognized and manipulated.

Instead of the light permeable electrode layer, the luminous body layer, the dielectric layer and the rear electrode layer on the main surface of substrate 11 of EL element 13 are all formed, as long as one layer containing a particularly expensive material is formed above diaphragm 15 or its vicinity where illumination is needed, material of a movable contact for manufacturing can be reduced. With this arrangement, EL element 13 can be manufactured inexpensively and less expensively installed on electronic equipment.

When EL element 13 on diaphragm 15 is pressed with a press-button or the like, EL element 13 warps downward depressing center top portion 15T, diaphragm 15 is then reversely moved and center portion 15F contacts fixed contact 8. Multiple electrical connections and disconnections between contacts 8 are thus made through diaphragm 15, and various functions of electronic equipment can be switched.

Since EL element 13 which is a major constituent of movable contact 16 is formed in the dome-like shape and the main surface of EL element 13 contacts intimately with almost a whole surface of diaphragm 15, malfunctions such as positional deviation and oblique pressing of the diaphragm is prevented, ensuring diaphragm 15 to move reversely.

As explained, according to the exemplary embodiment of the invention, essentially the dome-shape diaphragm 15 is attached to the specified spot of the main surface of EL element 13, constituting movable contact 16. With this arrangement, the spacer for placing diaphragm 15 is eliminated, and the simple structure and inexpensive movable contact and its manufacturing method are provided.

Moreover, since separator 17 is attached to the main surface of EL element 13 covering diaphragm 15, inconvenience is excluded, such as dust is attached to diaphragm 15 while movable contact 16 is transported or while the element is attached to wiring substrate 7, and a stable mechanical contact and electrical connection/disconnection between diaphragm 15 and fixed contact 8 is ensured.

Still moreover, by forming at least one layer out of the light permeable electrode layer, the luminous body layer and the rear electrode layer of EL element 13 in the vicinity of diaphragm 15, EL element 13 can be provided inexpensively.

### INDUSTRRIAAL APPLICABILITY

A movable contact and its manufacturing method of this invention provide a simple structure of the movable contact and an inexpensive production of the same. Because a diaphragm and an EL element are intimately attached, the movable contact can be provided avoiding an inconvenience such as a fall off and a positional deviation of the diaphragm. Because of it, it is useful for operating a variety of electronic equipment, and therefore its industrial applicability is high.

1. A movable contact comprising:
a permeable and bendable substrate;
an electroluminescence layer formed on a main surface of the substrate;
a plurality of diaphragms made of a thin conductive metal plate in a convex shape and adhered to a main surface side of the electroluminescence layer at a predetermined spacing between the diaphragms; and
a protrusion protruded toward an other main surface side of the substrate along the shape of the diaphragm.

2. The movable contact as defined in claim 1,
wherein the protrusion is composed of at least three layers, the substrate, the electroluminescence layer intimately connected with the substrate and the diaphragm intimately connected with the electroluminescence layer; and
wherein the protrusion is shaped similarly to the shape of the diaphragm.

3. The movable contact as defined in claim 1,
wherein a separator is placed at the main surface side of the electroluminescence layer, covering an other main surface side of the diaphragm.

4. The movable contact as defined in claim 1,
wherein at least one layer of a light permeable electrode layer, a luminous body layer and a rear electrode layer of the electroluminescence layer is formed in a vicinity of the diaphragm.

5. A manufacturing method of a movable contact comprising:
a step of preparing a light permeable and bendable substrate;
a step of forming an electroluminescence layer on a main surface of the substrate by printing;
a step of adhering a main surface of a diaphragm to a main surface side of the electroluminescence layer at a predetermined spacing with the other diaphragms;
a step of adhering a separator to an other main side of the diaphragm covering the diaphragm; and
a step of forming a protrusion by applying a heating and pressuring process from an other main surface of the substrate so that a part of the substrate and the electroluminescence layer is protruded toward the other main surface side of the substrate along a shape of the diaphragm.

6. The manufacturing method of the movable contact as defined in claim 5,
wherein the diaphragm and the protrusion are in a dome-like shape having a portion curved round.

7. The manufacturing method of the movable contact as defined in claim 5,
wherein the heating and pressuring process is applied from the other main side of the substrate where the diaphragm is not formed.

8. The manufacturing method of the movable contact as defined in claim 5,
wherein the diaphragm is put between or covered by the electroluminescence element and the separator when transferring the diaphragm to the following step.
